(19) United States
(12) Patent Application Publication
(10) Pub. No.: US 2024/0232585 A1
(43) Pub. Date: Jul. 11, 2024

(54) CHANNEL-GUIDED NESTED LOOP TRANSFORMATION AND SCALAR REPLACEMENT

(71) Applicant: QUALCOMM Incorporated, San Diego, CA (US)

(72) Inventor: Haijun ZHAO, Beijing (CN)

(21) Appl. No.: 18/558,978

(22) PCT Filed: Jul. 29, 2021
(86) PCT No.: PCT/CN2021/109181

§ 371 Date: Nov. 3, 2023

(51) Int. Cl. G06N 3/0464; G06N 3/09

(52) U.S. Cl. CPC G06N 3/0464; G06N 3/09

(57) ABSTRACT

A method receives a first program code including one or more nested loops. A loop order is determined for the nested loop(s). The determined loop order aligns an input data layout and an output data layout. The nested loop(s) are transformed based on the loop order. A second program code is generated based on the transformed nested loop(s).

### BACKGROUND

### Field

Aspects of the present disclosure generally relate to processing of convolutional computations.

### Background

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNNs), have numerous applications. In particular, these neural network architectures are used in various technologies, such as image recognition, pattern recognition, speech recognition, autonomous driving, and other classification tasks.

Deep neural networks have greatly improved streaming data (e.g., image, video, inertial measurement unit (IMU) data, radar, and WiFi) classification performance. It is desirable to incorporate such networks with Internet of things (IoT) devices, smartphones, or other low power devices that stream data. Unfortunately, the extensive resources consumed for classification due to the amount of computation involved makes it challenging to utilize deep neural networks on real-time, energy-sensitive applications.

### SUMMARY

The present disclosure is set forth in the independent claims, respectively. Some aspects of the disclosure are described in the dependent claims.

In an aspect of the present disclosure, a method is provided. The method includes receiving a first program code including one or more nested loops. The method also includes determining a loop order for the one or more nested loops, the loop order aligning an input data layout and an output data layout. Additionally, the method includes transforming the one or more nested loops based on the loop order. Further, the method includes generating a second program code based on the transformed one or more nested loops.

In an aspect of the present disclosure, an apparatus is provided. The apparatus includes a memory and one or more processors coupled to the memory. The processor(s) are configured to receive a first program code including one or more nested loops. The processor(s) are also configured to determine a loop order for the one or more nested loops. The loop order aligns an input data layout and an output data layout. In addition, the processor(s) are configured to transform the one or more nested loops based on the loop order. Further, the processor(s) are configured to generate a second program code based on the transformed one or more nested loops.

In an aspect of the present disclosure, an apparatus is provided. The apparatus includes means for receiving a first program code including one or more nested loops. The apparatus also includes means for determining a loop order for the one or more nested loops. The loop order aligns an input data layout and an output data layout. Additionally, the apparatus includes means for transforming the one or more nested loops based on the loop order. Further, the apparatus includes means for generating a second program code based on the transformed one or more nested loops.

In an aspect of the present disclosure, a non-transitory computer readable medium is provided. The computer readable medium has encoded thereon program code. The program code is executed by a processor and includes code to receive a first program code including one or more nested loops. The program code also includes code to determine a loop order for the one or more nested loops. The loop order aligns an input data layout and an output data layout. Additionally, the program code includes code to transform the one or more nested loops based on the loop order. Furthermore, the program code includes code to generate a second program code based on the transformed one or more nested loops.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating example convolution operations performed, for example, in one or more layers of an artificial neural network.

FIG. 6 is a diagram showing an example set of program code to be transformed, in accordance with aspects of the present disclosure.

FIGS. 7A and 7B illustrate example output program code, in accordance with aspects of the present disclosure.

FIG. 8 is a flow diagram illustrating a method for processing program code, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deep neural networks (DNNs) have greatly improved streaming data (e.g., image, video, inertial measurement unit (IMU) data, radar, and Wi-Fi) classification performance. It is desirable to incorporate such networks with Internet of things (IoT) devices, smartphones, or other low power devices for streaming data. Unfortunately, the extensive resources consumed for classification due to the amount of computation involved makes it challenging to utilize DNNs on real-time, energy-sensitive applications on low power systems, such as central processing units (CPUs), digital signal processors (DSPs), reduced instruction set computer (RISC) processors, microcontroller units (MCUs), and similar systems.

The memory system is one determinant of performance and energy consumption. That is, memory access is a significant cost for both energy and price for existing resource constrained low power systems, such as a central processing unit (CPU), digital signal processor (DSP), reduced instruction set computer (RISC) processor, a microcontroller unit (MCU), or the like. Larger memories may also result in increased power consumption and poor data locality, which may lead to increased cache misses and memory traffic. Many deep neural network computations occur in the convolution kernel, but a general matrix multiply (GEMM)-based convolution layer implementation uses additional memory space (e.g., C=H×W×K2, where K is the kernel size, C is the channel, H is the height and W is the weight).

Computer programming loops also play an important role in increasing execution speed and reducing overhead for scientific computation kernels, (e.g., a one-dimensional (1D), two-dimensional (2D), or three-dimensional (3D) convolutional kernel). Loops are programming structures that repeat a sequence of instructions until a condition is met. However, compilers may be inefficient for optimization of nested loops, which are programming structures in which one or more loops are included within another loop. It is also difficult to port existing optimizations from open source or vendor proprietary optimizations that are tightly bundled with special configurations.

In accordance with aspects of the present disclosure, instead of developing machine learning libraries or runtime, self-contained American National Standards Institute C programming language (ANSI-C) code is synthesized to increase, and in some aspects, maximize data locality and aid existing hardware and compilers for instruction scheduling.

In some aspects, a greedy process is implemented to determine an improved, and possibly optimal, loop ordering for a set of nested loops to align with both input data layout and output layout. In some aspects, the loop order may be determined via a greedy algorithm process. A greedy algorithm is an algorithm in which a set of resources are recursively divided based on a maximum immediate availability for that resource at a given stage of execution.

Additionally, the process may execute a stride-1 reference pattern to read an input feature map and write an output feature map. A stride-1 reference pattern may sequentially access each element or memory location for a multi-dimensional array, for example. The process may further execute an output channel-wise unrolling of one or more loops. Loop unrolling is a loop transformation that attempts to optimize execution speed at the expense of memory size. Loop unrolling attempts to reduce loop overhead by increasing the number of instructions executed between branching operations. Loop unrolling involves adding program code for the loop to be performed multiple times within the loop body. That is, the loop body may be replicated a number of times based on the conditions provided in the loop definition.

In some aspects, nested loops may be further transformed using scalar register replacement. Scalar register replacement involves replacing repeated accesses to an array element with a temporary scalar value. Rather than performing a memory access operation (e.g., read) to retrieve all of the data for each computation (e.g., multiply accumulate operation) from locations in a memory device (e.g., synchronous dynamic random access memory (SDRAM) or static random access memory (SRAM)), certain values may be temporarily stored in a local register (e.g., a processor register or cache). In some aspects, these temporary scalar values may be read-only or may be modified according to design preference, for example.

In some aspects, the scalar replacement may be performed in both the input and output channel direction. For example, in the input channel, rather than repeatedly reading each value of the kernel data (e.g., weights) used, for example in a convolution operation, the data array reference read for retrieving each value of the kernel data may be replaced by temporarily storing scalar values of the weights in a local register (e.g., processor register). On the other hand, in the output channel rather than repeatedly writing partial sums involved in a matrix multiplication operation, the scalar value for each of the computed partial sums (e.g., psum0-psumF) may be stored in a local register (e.g., a processor register) an output data array write.

Additionally, in some aspects, the nested loops may be re-ordered. That is, the sequence in which the loops of a set of nested loops are performed may be modified.

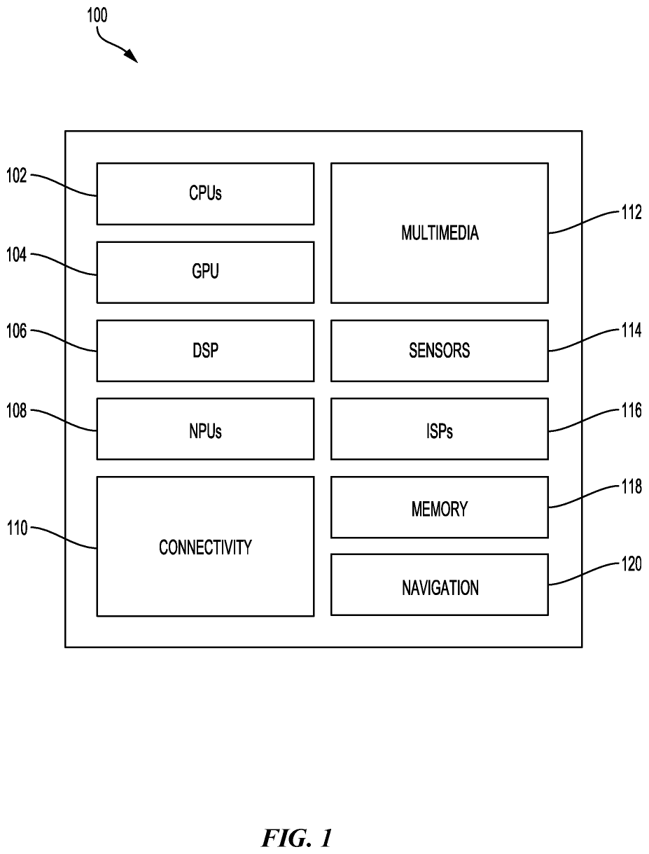

FIG. 1 illustrates an example implementation of a system-on-a-chip (SOC) 100, which may include a central processing unit (CPU) 102 or a multi-core CPU configured for processing multi-input, multi-output program code including nested loops. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a first program code including one or more nested loops. The general-purpose processor 102 may also include code to determine a loop order for the one or more nested loops, the loop order aligns an input data layout and an output data layout. In addition, the general-purpose processor 102 may include code to transform the one or more nested loops based on the loop order. The general-purpose processor 102 may further include code to generate a second program code based on the transformed one or more nested loops.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

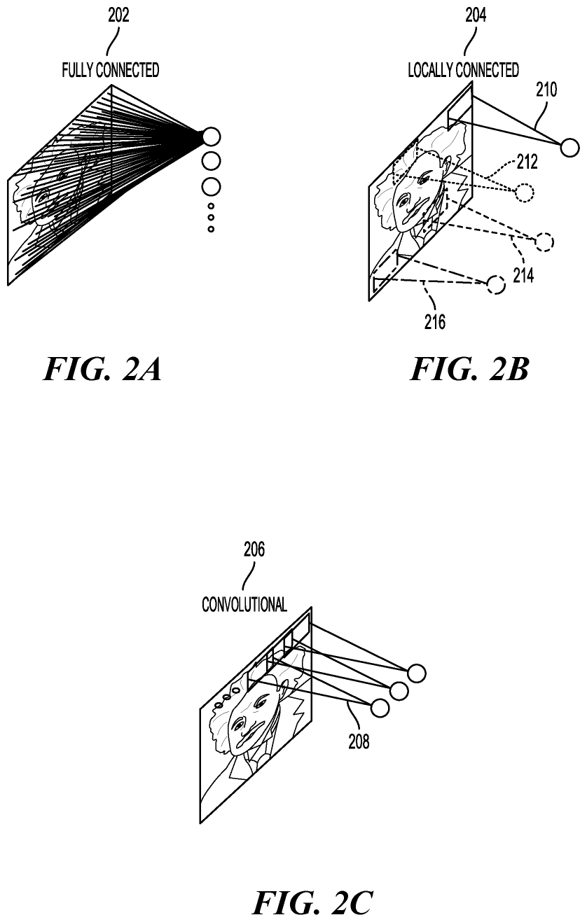

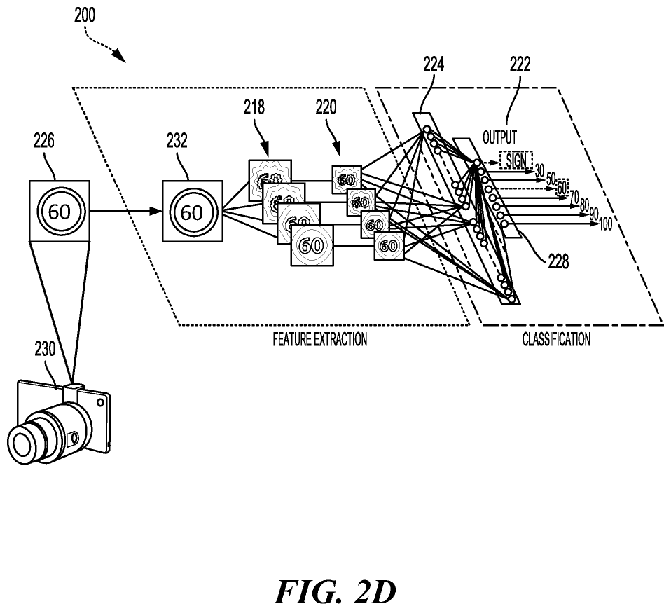

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

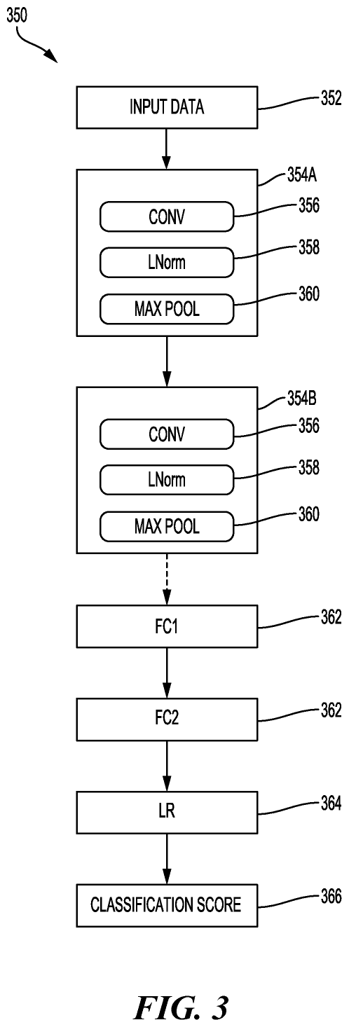

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

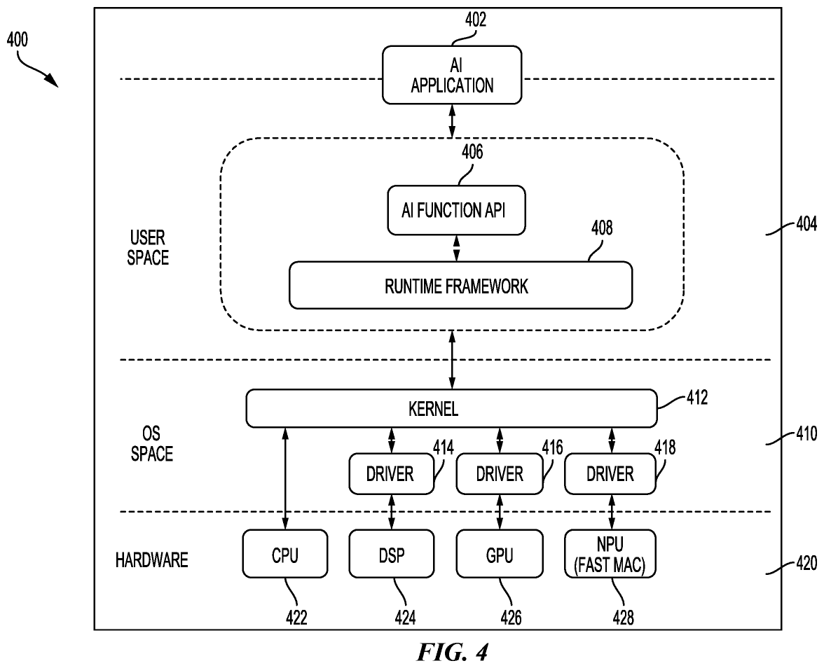

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to transforming a set of programming code instructions for improved processing of the programming code.

In accordance with aspects of the present disclosure, instead of developing machine learning libraries or runtime, self-contained American National Standards Institute C programming language (ANSI-C) code is formed to increase, and in some aspects, maximize data locality and aid existing hardware and compilers for instruction scheduling.

In some aspects, a greedy process is implemented to find or determine an improved, and possibly optimal, loop ordering for a set of nested loops The loop ordering may be determined, for example, based on the input channel and the output channel. The loop ordering may modify the sequence in which the loops of a set of nested loops are performed. In one example, the loop order may be modified according to align both of the input data layout (e.g., HᵢₙWᵢₙCᵢₙ) and the output data layout (HₒᵤₜWₒᵤₜCₒᵤₜ) with a loop index (e.g., HₒᵤₜWₒᵤₜCₒᵤₜ F_{y}FₓCᵢₙ). For example, in some aspects, a set of nested loop may be transformed by moving the input channel to the innermost loop. As such, a stride-1 reference pattern may be used to read an input feature map and write an output feature map.

Additionally, the nested loops may be transformed by loop unrolling. For example, output channel loop may be unrolled. As discussed, loop unrolling involves adding program code for the loop to be performed multiple times within the loop body.

In some aspects, nested loops may be further transformed using scalar register replacement. Scalar register replacement involves replacing repeated accesses to array elements stored in memory ((e.g., synchronous dynamic random access memory (SDRAM) or static random access memory (SRAM)) with temporary storage of corresponding scalar values in a local register to reduce processing time. Rather than performing a memory access operation (e.g., read) to retrieve all of the data for each computation (e.g., multiply accumulate operation) from locations in a memory device, certain values may be temporarily stored in a register (e.g., a processor register or cache). In some aspects, these temporary scalar values may be preserved as read-only or may be modified according to design preference, for example.

In accordance with aspects of the present disclosure, scalar replacement may be performed in both the input and output channel direction. For example, weight data array reference read may be replaced with a register scalar. Weight data array reference write may also be replaced with a register scalar.

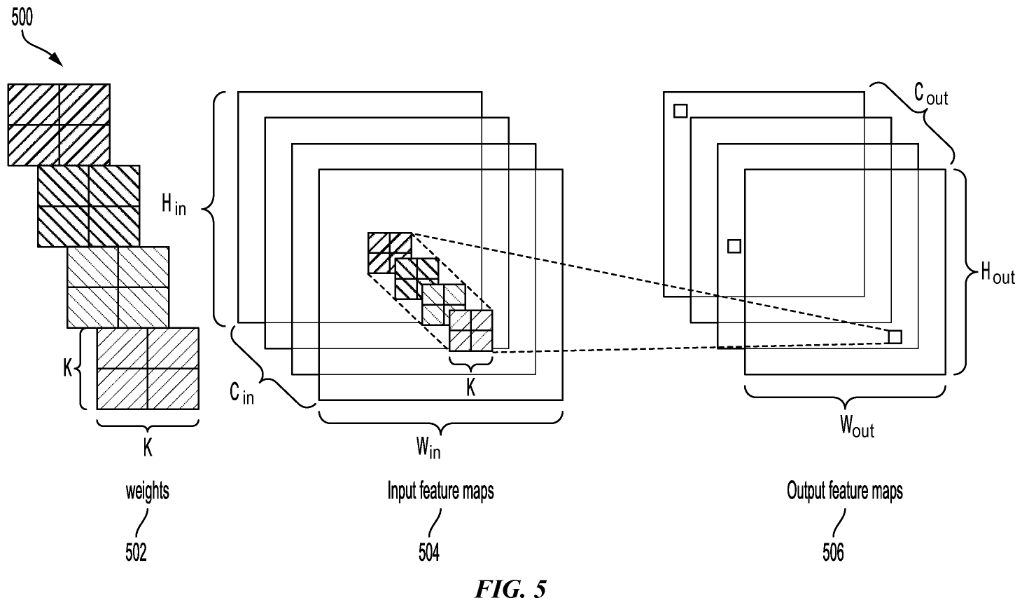

FIG. 5 is a block diagram illustrating example convolution operations performed, for example, in one or more layers of an artificial neural network 500. By way of example only, the artificial neural network 500 may be a convolutional neural network such as the deep convolutional network 350 (shown in FIG. 3).

Referring to FIG. 5, a set of K×K weights 502 may be applied to each of Cᵢₙ input feature maps 504, each having a height Hᵢₙ and a width Wᵢₙ. As shown in the example of FIG. 5, four kernels of K×K weights are included in the set of weights 502. However, the present disclosure is not so limiting and any number of kernels may be included in the set. Each kernel in the set of weights 502 is applied to corresponding receptive fields of the N input feature maps 504. A receptive field is a region the input feature that produces the output feature of any layer. The weight values of each kernel may be retrieved from memory with a stride-1 reference convolved with the input feature maps 504 according to the receptive field. The convolution operations for each kernel of the set 502 applied to a corresponding receptive field in the input feature maps 504 may produce a partial sum. The partial sums may in turn be accumulated to produce (′out output feature maps 506, each having a height Hₒᵤₜ and width Wₒᵤₜ, which may be written to memory in a stride-1 reference.

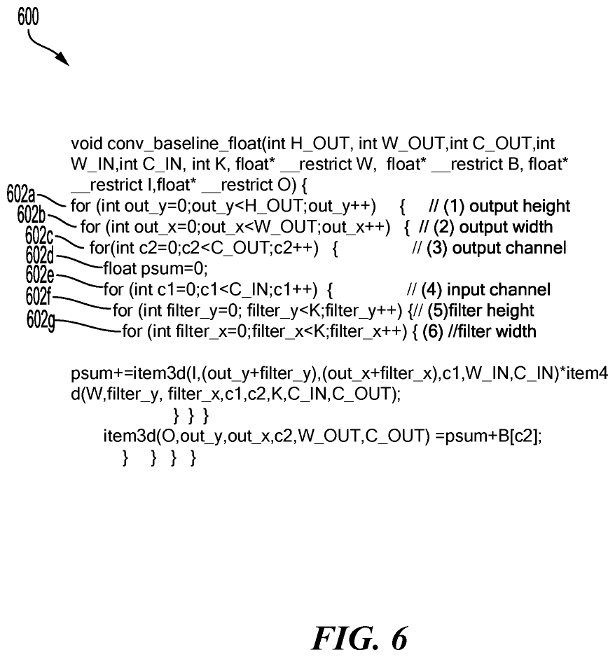

FIG. 6 is a diagram showing an example set of program code 600, in accordance with aspects of the present disclosure. Referring to FIG. 6, the example program code 600 may be received, for example, via a processor such as the CPU 102 (shown in FIG. 1). The program code 600 may include multiple loops 602a-g. The loops 602a-g are arranged in a nested structure. That is, an innermost loop 602g is executed before successively completing execution of outer loops 602a-f.

The program code 600 may be received as an input and may correspond to program code for operating an artificial neural network, for example. Of course, the disclosure is not so limiting and the input programming code may be any code structure including a set of nested loops.

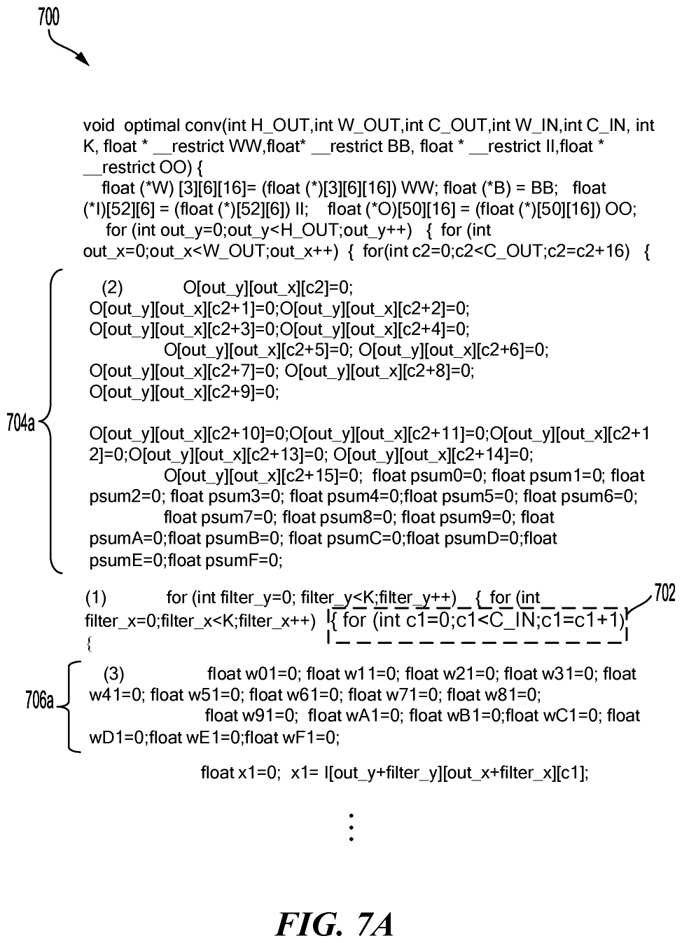

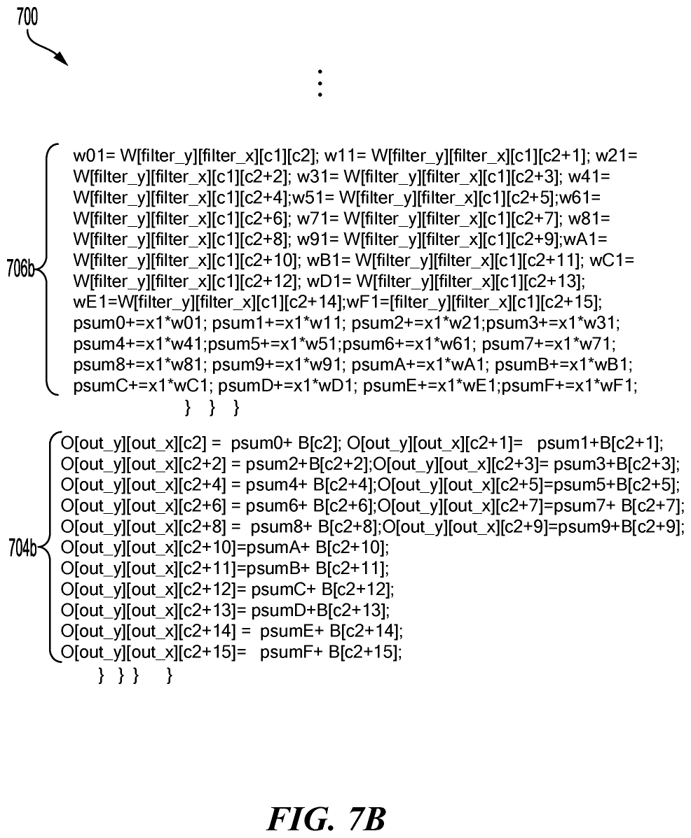

FIGS. 7A-B illustrate example output program code 700, in accordance with aspects of the present disclosure. Referring to FIGS. 7A-B, the example program code 600 (shown in FIG. 6) may be processed and transformed to generate output program code 700. Instead of developing machine learning libraries or runtime, self-contained program code (e.g., American National Standards Institute C programming language (ANSI-C) code)) may be synthesized. The synthesized code may be guided via a bi-directional channel (e.g., an input channel and an output channel). That is, the code may be adapted in the input channel (e.g., via scalar replacement of weights) or the output channel (e.g., via loop unrolling) or a combination thereof according to design preference, for example.

The transformation from program code 600 to output program code 700 includes reordering of the nested loops. As shown in FIG. 7A, the order of the loops in the nested loops (see FIG. 6, 602a-g) is changed such that the input channel loop (see FIG. 6, 602e) is moved to the innermost loop (702) of the nested loops. As discussed, the loop order may transformed such that the input data layout and output data layout are aligned with the loop index. By reordering the loop with such alignment, a stride-1 reference pattern may be applied to read an input feature map and write an output feature map.

In some aspects, the transformed loop order may be determined via a greedy search, reinforcement learning, or other automated algorithms, for instance. In addition, the transformed loop order may be determined based on hardware configuration, or a system or performance metric such as memory consumption, memory footprint size, processing speed, or power consumption, for instance.

Additionally, as shown in FIGS. 7A-B, one or more loops may be unrolled. For instance, in blocks 704a and 704b, the output channel loop corresponding to loop 602c of FIG. 6 is unrolled. As shown in blocks 704a iterations of the loop 602c are expanded to reduce or eliminate instructions that control the loop. In 704a, the arithmetic operations of initializing the outputs and partial sums are expanded and included in the loop body. As such, rather than performing the initializations over multiple iterations, all of the initializations are executed in sequence in one iteration. The loop unrolling may be performed to match the loop index for efficient access to input or output memory locations. While output channel is unrolled in the example of the FIGS. 7A and 7B, the present disclosure is not so limiting. Rather, in some aspects, the input channel may be unrolled in addition to, or instead of, the output channel. As such, the code ma

Similarly, in block 704b, program code for the arithmetic operation of accumulating the partial sums (e.g., partial sum produced in convolving a weights of a kernel with an input feature as illustrated in FIG. 5) to generate the output features are added to the loop body.

The loop transformation may also include scalar register replacement. That is, certain values may be stored in local registers to reduce the processing time associated with repeated access (e.g., array reference read) to values stored in memory such as SRAM or SDRAM, for instance. Referring to FIGS. 7A-B, in blocks 706a and 706b, rather than repeatedly accessing memory to retrieve an array value for W_OUT (as included in the code for loop 602b) to be compared to program input x, scalar values replace the values stored in memory. For example, in block 706b array elements W[filter_y][filter_x][c1][c2] are replaced by a scalar W01. The scalar (e.g., W01) may be stored in a processor register, for example. Accordingly, the weight values may be loaded into local registers (e.g., processor cache) to reduce the time for repeated memory access and thereby increase processing speed and improve performance.

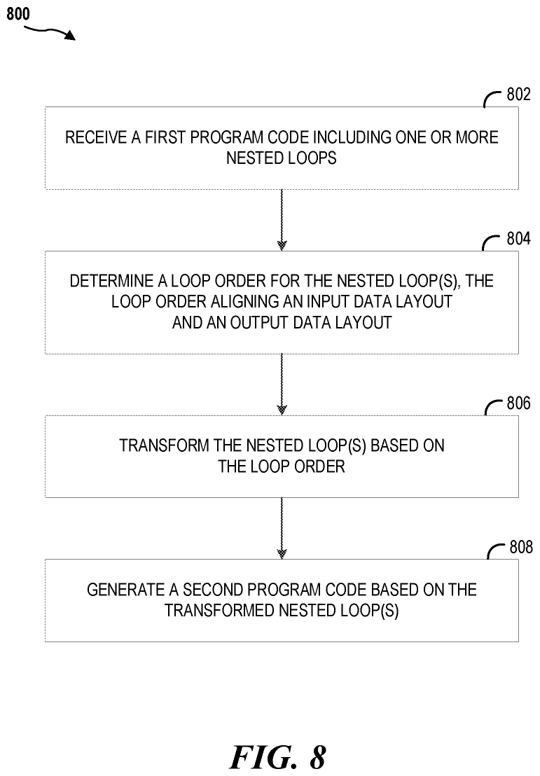

FIG. 8 is a flow diagram illustrating a method 800 for processing program code, in accordance with aspects of the present disclosure. As shown in FIG. 8, at block 802, a first program code including one or more nested loops is received. As described with reference to FIG. 6, a multi-input, multi-output program code may be received. As shown in the example of FIG. 6, the program code 600 may include multiple nested loops (e.g., six nested loops). In one example, the program code may include code to operate an artificial neural network such as deep convolutional network 350. For instance, the program code may include code to receive an input feature and perform a convolution operation to generate output feature maps.

At block 804, a loop order is determined for the one or more nested loops. The loop order aligns an input data layout and an output data layout.

At block 806, the one or more nested loops are transformed based on the loop order. In some aspects, the transformation may include unrolling one or more loops of the one or more nested loops according to an output channel. Additionally, the transformation may include replacing at least one array element for computing an output feature in an input channel or an output channel with a scalar stored in a register. The scalar may be stored in a processor register, for instance.

At block 808, a second program code is generated based on the transformed one or more nested loops. As shown in FIGS. 7A-B, program code 700 is generated by transforming program code 600 (shown in FIG. 6) using one or more of loop reordering, loop unrolling, and scalar replacement.

Implementation examples are described in the following numbered clauses:
1. A method, comprising:
receiving a first program code including one or more nested loops;
determining a loop order for the one or more nested loops, the loop order aligning an input data layout and an output data layout;
transforming the one or more nested loops based on the loop order; and
generating a second program code based on the transformed one or more nested loops.
2. The method of clause 1, further comprising unrolling at least one loop of the one or more nested loops.
3. The method of clause 1 or 2, in which the at least one loop includes an output loop.
4. The method of any of clauses 1-3, further comprising replacing at least one instruction for retrieving a value of one or more array elements for computing an output feature in an input channel from a memory unit with an instruction for storing a scalar value corresponding to the value of the one or more array elements in a local register.
5. The method of any of clauses 1-4, further comprising replacing at least one instruction for writing a value to one or more array elements for computing an output feature in an output channel to a memory unit with an instruction for storing the value corresponding to the value in a local register.
6. The method of any of clauses 1-5, in which the first program code is configured to convolve an input feature map array with a kernel array to produce an output feature map array.
7. The method of any of clauses 1-6, in which the second program code is configured to implement a stride-1 reference pattern for reading the input feature map array and writing the output feature map array.
8. An apparatus, comprising:
a memory; and
at least one processor coupled to the memory, the at least one processor is configured:
to receive a first program code including one or more nested loops;
to determine a loop order for the one or more nested loops, the loop order aligning an input data layout and an output data layout;
to transform the one or more nested loops based on the loop order; and
to generate a second program code based on the transformed one or more nested loops.
9 The apparatus of clause 8, in which the at least one processor is further configured to unroll at least one loop of the one or more nested loops.
10. The apparatus of clause 8 or 9, in which the at least one loop includes an output loop.
11. The apparatus of any of clauses 8-10, in which the at least one processor is further configured to replace at least one instruction for retrieving a value of one or more array elements for computing an output feature in an input channel from a memory unit with an instruction for storing a scalar value corresponding to the value of the one or more array elements in a local register.
12. The apparatus of any of clauses 8-11, in which the at least one processor is further configured to replace at least one instruction for writing a value to one or more array elements for computing an output feature in an output channel to a memory unit with an instruction for storing the value corresponding to the value in a local register.
13. The apparatus of any of clauses 8-12, in which the first program code is configured to convolve an input feature map array with a kernel array to produce an output feature map array.
14. The apparatus of any of clauses 8-13, in which the second program code is configured to implement a stride-1 reference pattern for reading the input feature map array and writing the output feature map array.
15. An apparatus, comprising:
means for receiving a first program code including one or more nested loops;
means for determining a loop order for the one or more nested loops, the loop order aligning an input data layout and an output data layout;
means for transforming the one or more nested loops based on the loop order; and
means for generating a second program code based on the transformed one or more nested loops.
16. The apparatus of clause 15, further comprising means for unrolling at least one loop of the one or more nested loops.
17. The apparatus of clause 15 or 16, in which the at least one loop includes an output loop.
18. The apparatus of any of clauses 15-17, further comprising means for replacing at least one instruction for retrieving a value of one or more array elements for computing an output feature in an input channel from a memory unit with an instruction for storing a scalar value corresponding to the value of the one or more array elements in a local register.
19. The apparatus of any of clauses 15-18, further comprising means for replacing at least one instruction for writing a value to one or more array elements for computing an output feature in an output channel to a memory unit with an instruction for storing the value corresponding to the value in a local register.
20. The apparatus of any of clauses 15-19, in which the first program code is configured to convolve an input feature map array with a kernel array to produce an output feature map array.
21. The apparatus of any of clauses 15-20, in which the second program code is configured to implement a stride-1 reference pattern for reading the input feature map array and writing the output feature map array.
22. A non-transitory computer readable medium having encoded thereon program code, the program code being executed by a processor and comprising: program code to receive a first program code including one or more nested loops;
program code to determine a loop order for the one or more nested loops, the loop order aligning an input data layout and an output data layout;
program code to transform the one or more nested loops based on the loop order; and
program code to generate a second program code based on the transformed one or more nested loops.
23. The non-transitory computer readable medium of clause 22, further comprising program code to unroll at least one loop of the one or more nested loops.
24. The non-transitory computer readable medium of clause 22 or 23, in which the at least one loop includes an output loop.
25. The non-transitory computer readable medium of any of clauses 22-24, further comprising program code to replace at least one instruction for retrieving a value of one or more array elements for computing an output feature in an input channel from a memory unit with an instruction for storing a scalar value corresponding to the value of the one or more array elements in a local register.
26. The non-transitory computer readable medium of any of clauses 22-25, further comprising program code to replace at least one instruction for writing a value to one or more array elements for computing an output feature in an output channel to a memory unit with an instruction for storing the value corresponding to the value in a local register.
27. The non-transitory computer readable medium of any of clauses 22-26, in which the first program code is configured to convolve an input feature map array with a kernel array to produce an output feature map array.
28. The non-transitory computer readable medium of any of clauses 22-27, in which the second program code is configured to implement a stride-1 reference pattern for reading the input feature map array and writing the output feature map array.

In some aspects, the receiving means, determining means, transforming means and/or generating means may be the CPU 102, program memory associated with the CPU 102, DSP 106, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method, comprising:
receiving a first program code including one or more nested loops;
determining a loop order for the one or more nested loops, the loop order aligning an input data layout and an output data layout;
transforming the one or more nested loops based on the loop order; and
generating a second program code based on the transformed one or more nested loops.

2. The method of claim 1, further comprising unrolling at least one loop of the one or more nested loops.

3. The method of claim 2, in which the at least one loop includes an output loop.

4. The method of claim 1, further comprising replacing at least one instruction for retrieving a value of one or more array elements for computing an output feature in an input channel from a memory unit with an instruction for storing a scalar value corresponding to the value of the one or more array elements in a local register.

5. The method of claim 1, further comprising replacing at least one instruction for writing a value to one or more array elements for computing an output feature in an output channel to a memory unit with an instruction for storing the value corresponding to the value in a local register.

6. The method of claim 1, in which the first program code is configured to convolve an input feature map array with a kernel array to produce an output feature map array.

7. The method of claim 6, in which the second program code is configured to implement a stride-1 reference pattern for reading the input feature map array and writing the output feature map array.

8. An apparatus, comprising:
a memory; and
at least one processor coupled to the memory, the at least one processor is configured:
to receive a first program code including one or more nested loops;
to determine a loop order for the one or more nested loops, the loop order aligning an input data layout and an output data layout;
to transform the one or more nested loops based on the loop order; and
to generate a second program code based on the transformed one or more nested loops.

9. The apparatus of claim 8, in which the at least one processor is further configured to unroll at least one loop of the one or more nested loops.

10. The apparatus of claim 9, in which the at least one loop includes an output loop.

11. The apparatus of claim 8, in which the at least one processor is further configured to replace at least one instruction for retrieving a value of one or more array elements for computing an output feature in an input channel from a memory unit with an instruction for storing a scalar value corresponding to the value of the one or more array elements in a local register.

12. The apparatus of claim 8, in which the at least one processor is further configured to replace at least one instruction for writing a value to one or more array elements for computing an output feature in an output channel to a memory unit with an instruction for storing the value corresponding to the value in a local register.

13. The apparatus of claim 8, in which the first program code is configured to convolve an input feature map array with a kernel array to produce an output feature map array.

14. The apparatus of claim 13, in which the second program code is configured to implement a stride-1 reference pattern for reading the input feature map array and writing the output feature map array.

15. An apparatus, comprising:
means for receiving a first program code including one or more nested loops;
means for determining a loop order for the one or more nested loops, the loop order aligning an input data layout and an output data layout;
means for transforming the one or more nested loops based on the loop order; and
means for generating a second program code based on the transformed one or more nested loops.

16. The apparatus of claim 15, further comprising means for unrolling at least one loop of the one or more nested loops.

17. The apparatus of claim 16, in which the at least one loop includes an output loop.

18. The apparatus of claim 15, further comprising means for replacing at least one instruction for retrieving a value of one or more array elements for computing an output feature in an input channel from a memory unit with an instruction for storing a scalar value corresponding to the value of the one or more array elements in a local register.

19. The apparatus of claim 15, further comprising means for replacing at least one instruction for writing a value to one or more array elements for computing an output feature in an output channel to a memory unit with an instruction for storing the value corresponding to the value in a local register.

20. The apparatus of claim 15, in which the first program code is configured to convolve an input feature map array with a kernel array to produce an output feature map array.

21. The apparatus of claim 20, in which the second program code is configured to implement a stride-1 reference pattern for reading the input feature map array and writing the output feature map array.

22. A non-transitory computer readable medium having encoded thereon program code, the program code being executed by a processor and comprising:
program code to receive a first program code including one or more nested loops;
program code to determine a loop order for the one or more nested loops, the loop order aligning an input data layout and an output data layout;
program code to transform the one or more nested loops based on the loop order; and
program code to generate a second program code based on the transformed one or more nested loops.

23. The non-transitory computer readable medium of claim 22, further comprising program code to unroll at least one loop of the one or more nested loops.

24. The non-transitory computer readable medium of claim 23, in which the at least one loop includes an output loop.

25. The non-transitory computer readable medium of claim 22, further comprising program code to replace at least one instruction for retrieving a value of one or more array elements for computing an output feature in an input channel from a memory unit with an instruction for storing a scalar value corresponding to the value of the one or more array elements in a local register.

26. The non-transitory computer readable medium of claim 22, further comprising program code to replace at least one instruction for writing a value to one or more array elements for computing an output feature in an output channel to a memory unit with an instruction for storing the value corresponding to the value in a local register.

27. The non-transitory computer readable medium of claim 22, in which the first program code is configured to convolve an input feature map array with a kernel array to produce an output feature map array.

28. The non-transitory computer readable medium of claim 27, in which the second program code is configured to implement a stride-1 reference pattern for reading the input feature map array and writing the output feature map array.
